(19) United States
(12) Patent Application Publication
(10) Pub. No.: US 2026/0177223 A1
(43) Pub. Date: Jun. 25, 2026

(54) LIGHTING DEVICE

(71) Applicant: STANLEY ELECTRIC CO., LTD., Tokyo (JP)

(72) Inventors: Masaru TANO, Tokyo (JP); Hiroaki IDO, Tokyo (JP); Tsukasa IMURA, Tokyo (JP); Mao SASABE, Tokyo (JP)

(73) Assignee: STANLEY ELECTRIC CO., LTD., Tokyo (JP)

(21) Appl. No.: 19/426,337

(22) Filed: Dec. 19, 2025

(30) Foreign Application Priority Data
Dec. 23, 2024 (JP) 2024-226393

(51) Int. Cl. F21V 5/00; F21V 7/05

(52) U.S. Cl. CPC F21V 5/00; F21V 7/05

(57) ABSTRACT

To provide a lighting device capable of causing a light-emitting region to emit light uniformly (or substantially uniformly). A lighting device comprising: a diffusion plate including one main surface, the other main surface on an opposite side of the one main surface, and an end surface between the one main surface and the other main surface, the diffusion plate containing a diffuser for scattering light; and at least one light source disposed on the one main surface side, wherein the end surface emits light by light from the light source entering the diffusion plate through the one main surface, being scattered by the diffuser, and exiting from the end surface.

### CROSS-REFERENCE TO RELATED APPLICATION

This application is based upon and claims the benefit of priority from Japanese patent application No. 2024-226393, filed on Dec. 23, 2024, the disclosure of which is incorporated herein in its entirety by reference.

### BACKGROUND

The present disclosure relates to a lighting device.

A lighting device including a columnar portion made of a light-transmissive resin and a light source disposed so as to face one end surface of the columnar portion is known (see, for example, Patent Literature 1). In this lighting device, light emitted from the light source enters the columnar portion through one end surface and exits through the other end surface, whereby a light-emitting region is formed on the other end surface.

[Patent Literature 1] Japanese Unexamined Patent Application Publication JP 2004-361968

### SUMMARY

However, in the lighting device described in Patent Literature 1, since the other end surface is arranged on the optical axis of the light source, a point-like light emission occurs, resulting in a problem that the light-emitting region cannot emit light uniformly (or substantially uniformly).

The present disclosure has been made to solve such a problem, and an object thereof is to provide a lighting device capable of causing a light-emitting region to emit light uniformly (or substantially uniformly).

A lighting device according to an example aspect of the present disclosure includes: a diffusion plate including one main surface, the other main surface on an opposite side of the one main surface, and an end surface between the one main surface and the other main surface, the diffusion plate containing a diffuser for scattering light; and at least one light source disposed on the one main surface side, wherein the end surface emits light by light from the light source entering the diffusion plate through the one main surface, being scattered by the diffuser, and exiting from the end surface.

By such a configuration, it is possible to make a light-emitting region emit light uniformly or substantially uniformly. Furthermore, in the above lighting device, a first reflecting surface may further be provided on the other main surface side, the first reflecting surface being configured to reflect light from the light source that has transmitted through the diffusion plate. In this case, the end surface may emit light by light from the light source entering the diffusion plate through the one main surface and being scattered by the diffuser, and by reflected light from the first reflecting surface entering the diffusion plate through the other main surface and being scattered by the diffuser, and exiting from the end surface.

In the above lighting device, the lighting device may further include a second reflecting surface disposed on the one main surface side and configured to reflect light from the light source, wherein the end surface emits light by light from the light source entering the diffusion plate through the one main surface and being scattered by the diffuser, by reflected light from the first reflecting surface entering the diffusion plate through the other main surface and being scattered by the diffuser, and by reflected light from the second reflecting surface entering the diffusion plate through the one main surface and being scattered by the diffuser, and exiting from the end surface.

In the above lighting device, the first reflecting surface and the second reflecting surface may be each made of a highly reflective member.

In the above lighting device, the lighting device may further include a light-shielding member that surrounds at least a part of the end surface in a front view.

In the above lighting device, the light source may be disposed at a position where light within a half-value angle with respect to an optical axis of the light source does not directly exit from the end surface.

In the above lighting device, the light source may be a film light source including an elongated film having flexibility and extending in a longitudinal direction, and at least one semiconductor light-emitting element fixed to at least a surface of the film.

In the above lighting device, the semiconductor light-emitting elements are a plurality of semiconductor light-emitting elements having different emission colors from each other, and the semiconductor light-emitting elements are arranged in the longitudinal direction.

According to the present disclosure, it is possible to provide a lighting device capable of causing a light-emitting region to emit light uniformly (or substantially uniformly).

The above and other objects, features and advantages of the present disclosure will become more fully understood from the detailed description given hereinbelow and the accompanying drawings.

### BRIEF DESCRIPTION OF DRAWINGS

FIG. 1 is a front view of a lighting device 10;

FIG. 2 is a sectional view taken along line II-II of FIG. 1;

FIG. 3 is a front view of the lighting device 10 with a light-shielding member 40 omitted;

FIG. 4 is a diagram for explaining the width W1 and the like of the diffusion plate 60;

FIG. 5 is a front view (partially enlarged view) of the lighting device 10 with the light-shielding member 40 omitted;

FIG. 6 illustrates the comparative example;

FIG. 7 illustrates a modified example of the sealing material 53;

FIG. 8 illustrates a modified example using a reflective layer 70;

FIG. 9 illustrates a modified example in which the diffusion plate 60 is disposed on the outer wall surface 22;

FIG. 10 illustrates a modified example in which the light source 50 is also disposed on the other main surface 62 side of the diffusion plate 60; and

FIG. 11 illustrates a modified example in which a plurality of semiconductor light-emitting elements that emit light of different colors from each other are used as the semiconductor light-emitting element 52.

### DESCRIPTION OF EMBODIMENTS

Hereinafter, a lighting device 10 according to an embodiment of the present disclosure will be described with reference to the accompanying drawings. In the drawings, the same reference numerals denote corresponding components, and redundant descriptions will be omitted.

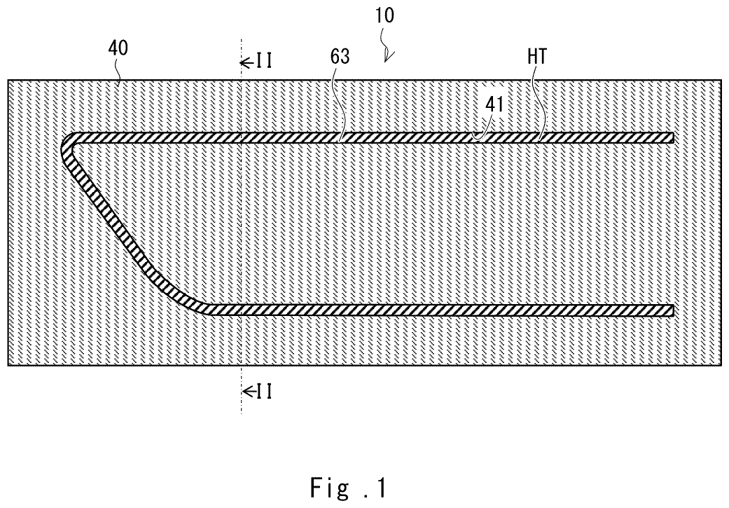

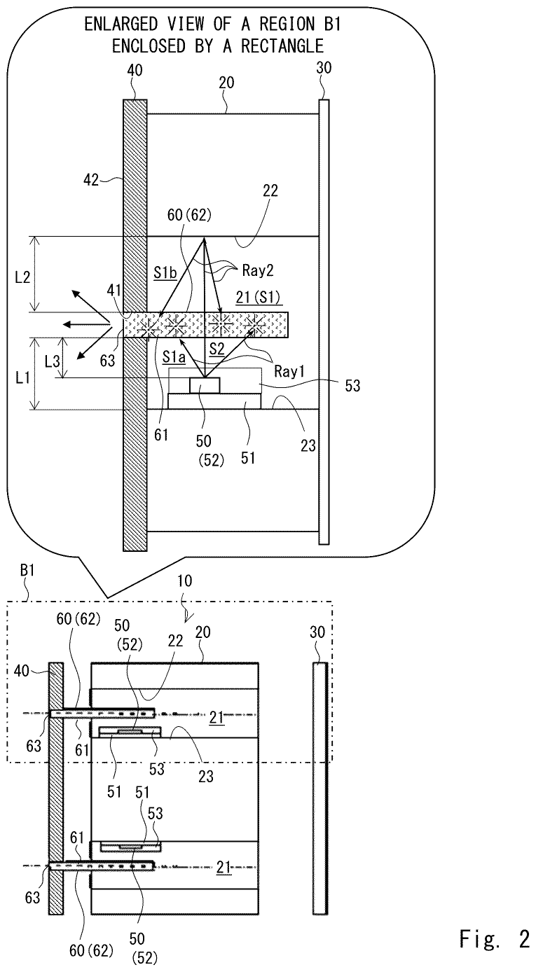

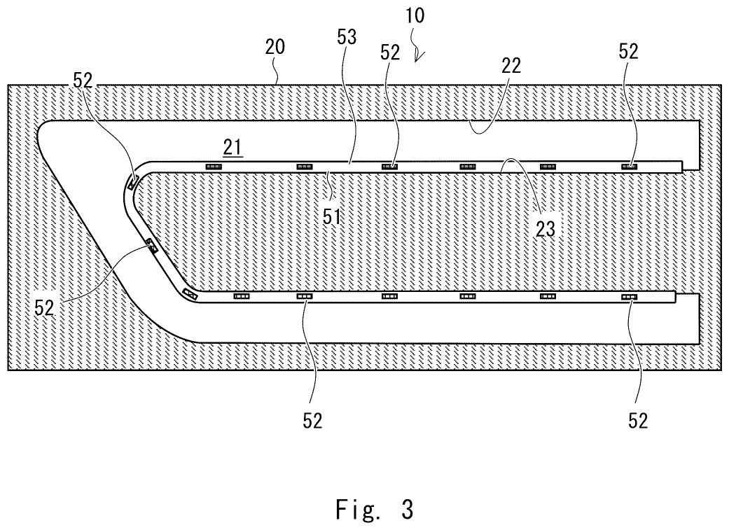

FIG. 1 is a front view of a lighting device 10, FIG. 2 is a sectional view taken along line II-II of FIG. 1, and FIG. 3 is a front view of the lighting device 10 with a light-shielding member 40 omitted.

The lighting device 10 of the present embodiment is a lighting device capable of forming a narrow, line-shaped light-emitting region. In FIG. 1, a hatched region HT represents an example of the narrow, line-shaped light-emitting region, which corresponds to an end surface 63 of a diffusion plate 60. The lighting device 10 may be applied to, for example, an in-vehicle lamp (such as interior illumination) or a game product.

As shown in FIG. 2, the lighting device 10 includes an intermediate housing 20, a bottom portion 30, a light-shielding member 40, a light source 50, and a diffusion plate 60.

The intermediate housing 20 is, for example, a housing having a rectangular parallelepiped shape and includes a through-hole 21 that penetrates between one surface (the left surface in FIG. 2) and the other surface (the right surface in FIG. 2). The through-hole 21 is a U-shaped through-hole in a front view, surrounded by an outer wall surface 22 and an inner wall surface 23 (see FIG. 3).

One end (the left side in FIG. 2) of the through-hole 21 is closed by a light-shielding member 40 attached to the intermediate housing 20. On the other hand, the other end (the right side in FIG. 2) of the through-hole 21 is closed by a bottom portion 30 attached to the intermediate housing 20.

The intermediate housing 20 and the bottom portion 30 are each made of a highly reflective member such as white acrylic (or white resin), for example, a reflective member having a reflectance of 90% or higher, or a reflective member having a higher reflectance than that of the diffusion plate 60. The outer wall surface 22 and the inner wall surface 23 of the through-hole 21 function as reflective surfaces (diffuse reflective surfaces), respectively. The outer wall surface 22 is an example of a first reflective surface of the present disclosure, and the inner wall surface 23 is an example of a second reflective surface of the present disclosure.

A space S1 (see FIG. 2) surrounded by the outer wall surface 22 and the inner wall surface 23 of the through-hole 21, the bottom portion 30, and the light-shielding member 40 is provided with a light source 50 and a diffusion plate 60.

The light source 50 is, for example, a film light source such as an OP-FILM. The film light source includes an elongated film 51 that has flexibility and extends in a longitudinal direction, a plurality of semiconductor light-emitting elements 52 fixed to the film 51, and a sealing material 53 covering the semiconductor light-emitting elements 52.

The film 51 is, for example, a transparent film (for example, a polyimide transparent film). The film 51 may alternatively be a semi-transparent film or an opaque film.

The semiconductor light-emitting element 52 is a light source having a Lambertian light distribution characteristic, and is, for example, an LED that emits red light. The emission color of the semiconductor light-emitting element 52 may be a color other than red. The semiconductor light-emitting elements 52 are arranged in a single row at predetermined intervals along the longitudinal direction of the film 51 (see FIG. 3). The arrangement interval of the semiconductor light-emitting elements 52 will be described later in more detail.

The light source 50 is attached to the inner wall surface 23 of the intermediate housing 20 in a wound state by a known means, for example, an adhesive (double-sided tape). As a result, the semiconductor light-emitting element 52 is disposed on one main surface 61 side of the diffusion plate 60 so as to face the one main surface 61 with a space S2 interposed therebetween (see FIG. 2). The sealing material 53 is, for example, a layered sealing material that covers the semiconductor light-emitting element 52 (see FIGS. 2 and 3). The material of the sealing material 53 is, for example, a silicone resin. When the thickness of the layered silicone resin exceeds 350 μm, strong wide-angle light that causes stray light is generated; therefore, the thickness is preferably 350 μm or less.

The diffusion plate 60 includes one main surface 61, the other main surface 62 on the opposite side thereof, and an end surface 63 between the one main surface 61 and the other main surface 62 (see FIG. 2), and is a diffusion plate containing a diffusing agent for scattering light. The transmittance of the diffusion plate 60 is adjusted to 8% to 70% by adjusting the concentration of the diffusing material. By adopting this range, the diffusion plate 60 has a milky-white texture, thereby providing an advantage that designability and marketability are improved. On the other hand, when the range is exceeded (particularly when the upper limit is exceeded), the light-emitting portion becomes excessively white, resulting in deterioration of designability and marketability. The one main surface 61 and the other main surface 62 are parallel planes to each other and extend, for example, in a U-shape along the inner wall surface 23 of the intermediate housing 20.

The diffusion plate 60 can be manufactured by mixing, for example, a resin (acrylic resin) and a white pigment powder of TiO2, for example, by mixing 90 wt % of acrylic resin and 10 wt % of TiO₂ (for example, a transmittance of 58%). However, the material is not limited thereto, and PC (polycarbonate) may be used as the resin. Further, the white pigment powder may be alumina or the like as long as it has a higher refractive index than that of the resin. By adjusting the ratio between the resin and the white pigment, for example, by increasing the proportion of the white pigment component, the transmittance can be reduced, and a diffusion plate having a transmittance of 8% to 70% can be produced. That is, as the weight percentage of the white pigment increases, the transmittance decreases, and as the weight percentage decreases, the transmittance increases.

The end surface 63 is, for example, a plane orthogonal to the one main surface 61 and the other main surface 62. The diffusion plate 60 is fixed to the light-shielding member 40 by a known means such as an adhesive or fitting, in a state where the end surface 63 is exposed from a through-hole 41 formed in the light-shielding member 40. In FIG. 1, a hatched region HT represents the end surface 63. The through-hole 41 is formed in a U-shape corresponding to the through-hole 21. The end surface 63 exposed from the through-hole 41 is disposed on the same plane as a surface 42 of the light-shielding member 40 (see FIG. 2). Although not shown, the end surface 63 may be disposed at a position one step higher than the surface 42 of the light-shielding member 40, or may be disposed at a position one step lower than the surface 42 of the light-shielding member 40.

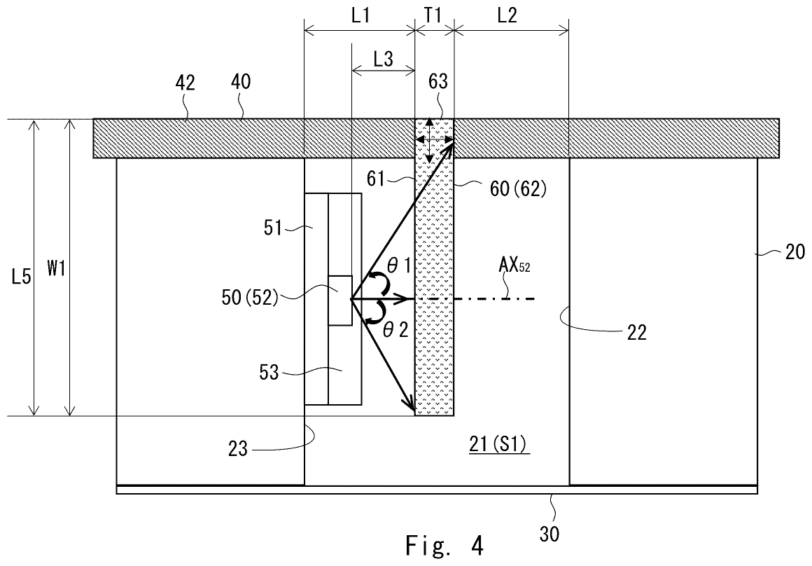

FIG. 4 is a diagram for explaining the width W1 and the like of the diffusion plate 60. In FIG. 4, an angle θ1 represents an angle of +60 degrees with respect to an optical axis AX52 of the semiconductor light-emitting element 52, and an angle θ2 represents an angle of −60 degrees with respect to the optical axis AX52 of the semiconductor light-emitting element 52. The angles θ1 and θ2 are half-value angles, which represent an angular range in which the intensity of light emitted from the semiconductor light-emitting element 52 becomes half of the maximum value. The width W1 of the diffusion plate 60 is set to a dimension such that light within the half-value angle (here, the angles θ1 and θ2, i.e., an angular range of ±60 degrees) with respect to the optical axis AX52 of the semiconductor light-emitting element 52 is irradiated thereto. The thickness T1 of the diffusion plate 60 is set to a thickness (for example, 2 mm) that is determined so that light within the half-value angle is not directly emitted from the end surface 63. The light source 50 (the semiconductor light-emitting element 52) is preferably disposed as close to the end surface 63 as possible while satisfying the above conditions.

The brightness (luminance distribution) of a light-emitting region (a narrow, line-shaped light-emitting region) formed on the end surface 63 is adjusted by adjusting a thickness T1 of the diffusion plate 60, a distance L1 between one main surface 61 of the diffusion plate 60 and an inner wall surface 23 of the through-hole 21 of the intermediate housing 20, a distance L2 between the other main surface 62 of the diffusion plate 60 and an outer wall surface 22 of the through-hole 21 of the intermediate housing 20, and a distance L3 between the one main surface 61 of the diffusion plate 60 and the semiconductor light-emitting element 52. The conditions (the thickness T1 and the respective distances L1 to L3) for making the brightness of the light-emitting region formed on the end surface 63 uniform (or substantially uniform) can be found by using a predetermined simulation software.

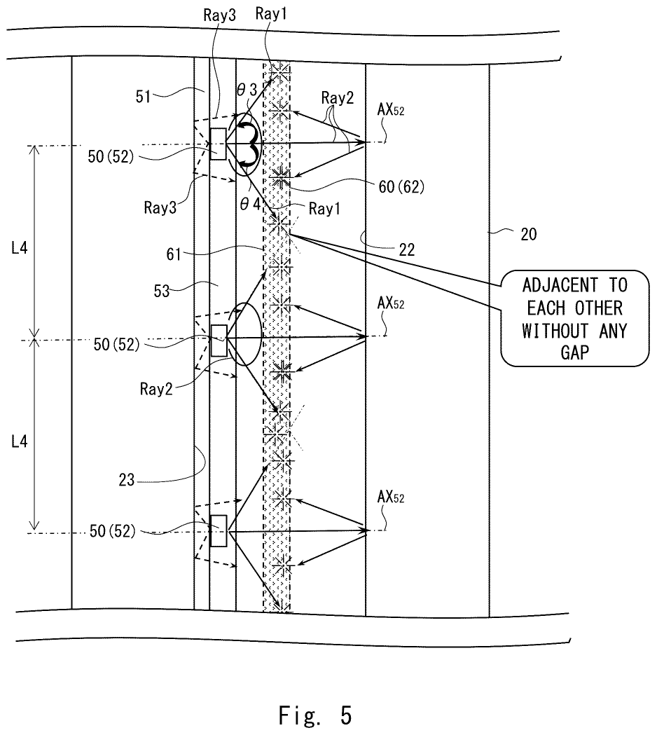

FIG. 5 is a front view (partially enlarged view) of the lighting device 10 with the light-shielding member 40 omitted. In FIG. 5, an angle θ3 represents an angle of +60 degrees with respect to an optical axis AX52 of the semiconductor light-emitting element 52, and an angle θ4 represents an angle of −60 degrees with respect to the optical axis AX52 of the semiconductor light-emitting element 52. The angles θ3 and θ4 are half-value angles, which represent an angular range in which the intensity of light emitted from the semiconductor light-emitting element 52 becomes half of the maximum value. A placement interval L4 of the semiconductor light-emitting elements 52 is set such that light within the half-value angle (here, an angular range of ±60 degrees) with respect to the optical axis AX52 of the semiconductor light-emitting element 52 (see Rays 1 and 2 in FIG. 5), among light emitted from adjacent semiconductor light-emitting elements 52, are adjacent to each other without gaps within the diffusion plate 60 (see FIG. 5).

In the lighting device 10 having the above-described configuration, when the light source 50 (the semiconductor light-emitting element 52) is turned on, as shown in FIGS. 2 and 5, a part of light (Ray 1) emitted from the light source 50 (the semiconductor light-emitting element 52) enters the diffusion plate 60 from one main surface 61 of the diffusion plate 60, is scattered by a diffusing agent, and exits from the end surface 63 of the diffusion plate 60. Another part of light (Ray 2) emitted from the semiconductor light-emitting element 52 passes through the diffusion plate 60 and is reflected by an outer wall surface 22 of the through-hole 21 of the intermediate housing 20. The reflected light (Ray 2) enters the diffusion plate 60 from the other main surface 62 of the diffusion plate 60, is scattered by the diffusing agent, and exits from the end surface 63 of the diffusion plate 60. Furthermore, another part of light (Ray 3) (see FIG. 5) emitted from the semiconductor light-emitting element 52 is reflected by an inner wall surface 23 of the through-hole 21 of the intermediate housing 20. The reflected light (Ray 3) travels along the same optical path as the lights Ray 1 and Ray 2 described above, and exits from the end surface 63 of the diffusion plate 60.

As described above, by light Rays 1 to 3 being emitted from the end surface 63 of the diffusion plate 60, a narrow, line-shaped light-emitting region (see hatched region HT in FIG. 1) is formed on the end surface 63 of the diffusion plate 60. At this time, since the light emitted from the light source 50 enters the diffusion plate 60 from both surfaces (the one main surface 61 and the other main surface 62), light utilization efficiency is improved.

The inventors of the present invention have confirmed that, when using the diffusion plate 60 having a thickness T1 of 2 mm and a transmittance of 58%, the semiconductor light-emitting element 52 having a size of 245×135×100 μm, and the intermediate housing 20 and the bottom portion 30 each made of a highly reflective member having a reflectance of 90% or higher, a narrow, line-shaped light-emitting region having a luminance ratio of ±15% (an example of a condition for making the light-emitting region visually uniform or substantially uniform) can be formed on the end surface 63.

Next, the effects of the lighting device 10 having the above-described configuration will be described in comparison with a comparative example.

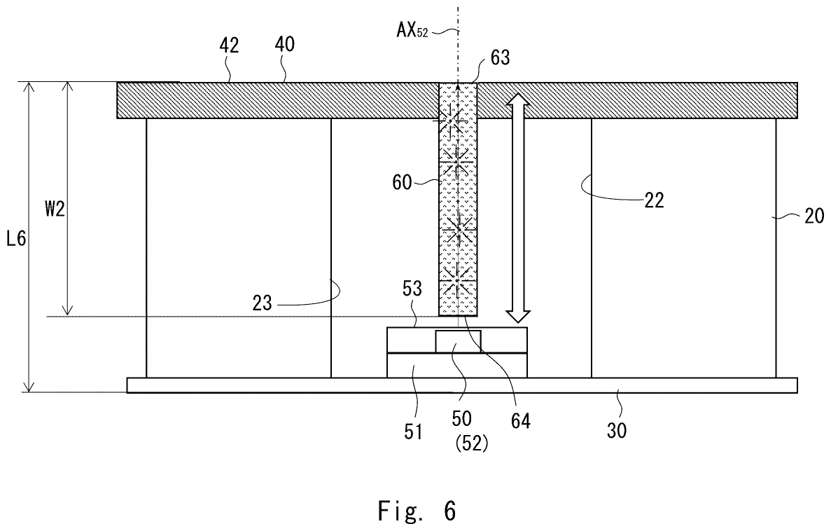

FIG. 6 illustrates the comparative example.

As shown in FIG. 6, in the comparative example, the semiconductor light-emitting element 52 is disposed so as to face an end surface 64 opposite to the end surface 63. Other configurations are the same as those of the lighting device 10 having the above-described configuration.

In the comparative example 1, since the light source 50 (the semiconductor light-emitting element 52) is disposed so as to face the end surface 64 opposite to the end surface 63, the length L6 (see FIG. 6) of the lighting device becomes longer. In contrast, in the lighting device 10 having the above-described configuration, since the light source 50 (the semiconductor light-emitting element 52) is disposed on the one main surface 61 side, the length L5 (see FIG. 4) of the lighting device can be made shorter, which is an advantage.

In the comparative example 1, since the end surface 63 is disposed on the optical axis AX52 of the light source 50 (the semiconductor light-emitting element 52) (see FIG. 6), point light emission occurs, and the light-emitting region formed on the end surface 63 cannot be made to emit light uniformly (or substantially uniformly). In contrast, in the lighting device 10 having the above-described configuration, since light within the half-value angle (here, the angles θ1 and θ2, that is, an angular range of ±60 degrees; see FIG. 4) is not directly emitted from the end surface 63, point light emission is suppressed, and the light-emitting region formed on the end surface 63 can emit light uniformly (or substantially uniformly), which is an advantage.

In the comparative example 1, uniform light emission can be achieved by increasing the width W2 (see FIG. 6) of the diffusion plate 60. In contrast, in the lighting device 10 having the above-described configuration, the light source 50 (the semiconductor light-emitting element 52) is disposed on the one main surface 61 side, and therefore, as compared with the comparative example 1, the distance between the light incident surface (the main surface 61) and the light emitting surface (the end surface 63) becomes shorter. Accordingly, even when the width W1 (see FIG. 4) of the diffusion plate 60 is made narrower, uniform light emission can be achieved, which is an advantage.

In the comparative example 1, when the width W2 (see FIG. 6) of the diffusion plate 60 is not increased, uniform light emission can be achieved by increasing the concentration of a diffusing agent in the diffusion plate 60. However, as the concentration of the diffusing agent increases, the transmittance decreases, and the brightness (luminance) of a light-emitting region (a narrow, line-shaped light-emitting region) formed on the end surface 63 is reduced. In contrast, in the lighting device 10 having the above-described configuration, the light source 50 (the semiconductor light-emitting element 52) is disposed on the one main surface 61 side, and therefore, as compared with the comparative example 1, since the distance between the light incident surface (the main surface 61) and the light emitting surface (the end surface 63) becomes shorter, uniform light emission can be achieved without increasing the concentration of the diffusing agent (without lowering the transmittance). Therefore, in the lighting device 10 having the above-described configuration, as compared with the comparative example 1, it is possible to suppress a decrease in brightness (luminance) of the light-emitting region (the narrow, line-shaped light-emitting region) formed on the end surface 63, which is an advantage.

As described above, according to the present embodiment, it is possible to provide a lighting device 10 capable of making a light-emitting region emit light uniformly (or substantially uniformly).

Next, a modified example will be described.

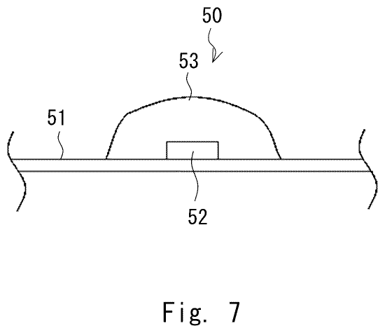

FIG. 7 illustrates a modified example of the sealing material 53.

In the above embodiment, an example has been described in which a layered sealing material (see FIGS. 2 and 3) covering the semiconductor light-emitting element 52 is used as the sealing material 53. However, the present invention is not limited thereto. For example, as shown in FIG. 7, a dome-shaped sealing material that covers the semiconductor light-emitting element 52 may be used as the sealing material 53. When the dome-shaped sealing material is used, since the light is condensed, the directivity characteristics become stable, stray light is prevented from occurring, and the influence caused by the thickness is reduced, which is an advantage.

Further, the light source 50 is not limited to the film light source, and a light source in which the semiconductor light-emitting element 52 is mounted on a general substrate (for example, a metal substrate) may be used.

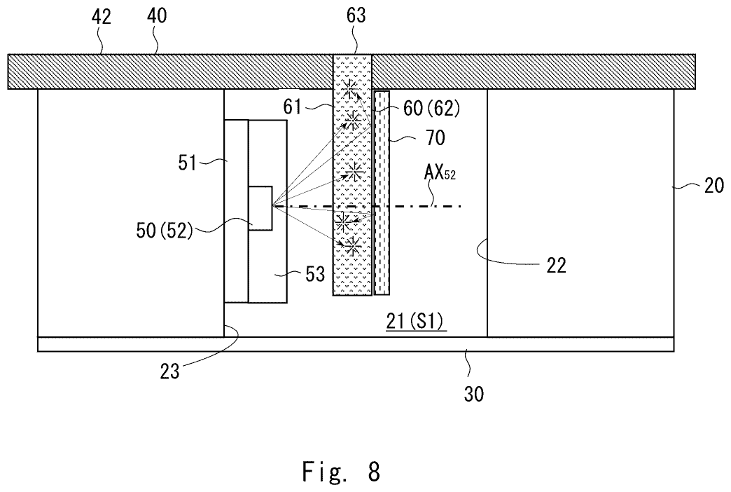

FIG. 8 illustrates a modified example using a reflective layer 70.

As shown in FIG. 8, a reflective layer 70 that functions in the same manner as the outer wall surface 22 may be formed on the other main surface 62 of the diffusion plate 60. The reflective layer 70 may be a reflective layer or a diffused reflective layer of aluminum.

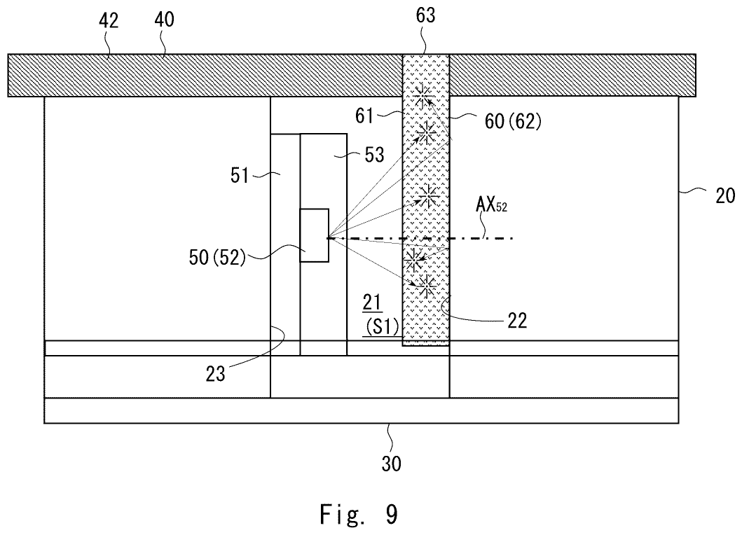

FIG. 9 illustrates a modified example in which the diffusion plate 60 is disposed on the outer wall surface 22.

As shown in FIG. 9, the diffusion plate 60 may be disposed on the outer wall surface 22. In this case, the outer wall surface 22 and the other main surface 62 may be bonded to each other, or a gap may be provided between the outer wall surface 22 and the other main surface 62.

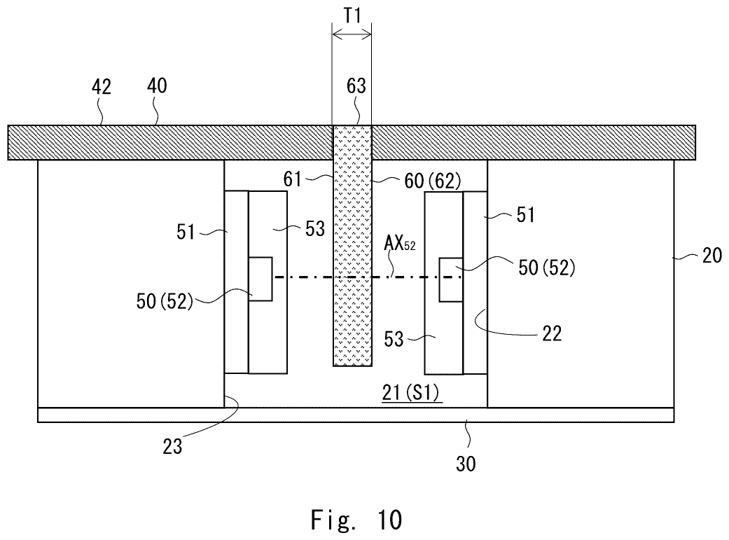

FIG. 10 illustrates a modified example in which the light source 50 is also disposed on the other main surface 62 side of the diffusion plate 60.

As shown in FIG. 10, the light source 50 may be disposed not only on one main surface 61 side of the diffusion plate 60 but also on the other main surface 62 side thereof. In this manner, even when, for example, the thickness T1 becomes large, it is possible to form a narrow line-shaped light-emitting region that emits light uniformly or substantially uniformly on the end surface 63.

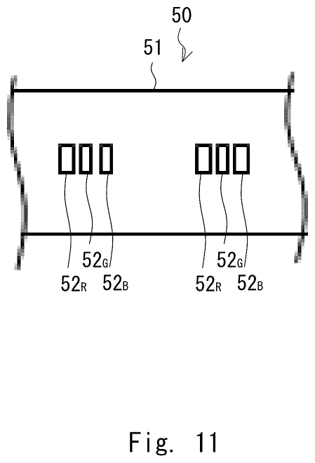

FIG. 11 illustrates a modified example in which a plurality of semiconductor light-emitting elements that emit light of different colors from each other are used as the semiconductor light-emitting element 52.

In the above embodiment, an example has been described in which an LED that emits light of a single color is used as the semiconductor light-emitting element 52; however, the present invention is not limited thereto. For example, as shown in FIG. 11, a plurality of semiconductor light-emitting elements that emit light of different colors from each other may be used as the semiconductor light-emitting element 52. FIG. 11 shows an example in which an LED 52R that emits red light, an LED 52G that emits green light, and an LED 52B that emits blue light are used as the semiconductor light-emitting element 52. In this case, it is desirable that the plurality of semiconductor light-emitting elements (in this case, LEDs 52R, 52G, and 52B) be arranged in the longitudinal direction (left-right direction in FIG. 9) of the film light source 50 (film 51). In this manner, the width W1 (see FIG. 5) of the diffusion plate 60 can be made the same as that when an LED that emits light of a single color is used as the semiconductor light-emitting element 52.

In the above embodiment, an example has been described in which the light-shielding member 40 is used; however, the present invention is not limited thereto. For example, the light-shielding member 40 may be omitted, or a transparent member may be used instead of the light-shielding member 40.

In the above embodiment, an example has been described in which a plurality of semiconductor light-emitting elements 52 are used; however, the present invention is not limited thereto. The semiconductor light-emitting element 52 may be one or more.

All numerical values shown in the above embodiments are merely examples, and it is of course possible to use any other appropriate numerical values different therefrom.

Each of the above embodiments is merely illustrative in every respect. The present disclosure is not to be construed in a limited sense by the description of the above embodiments. The present disclosure can be implemented in various other forms without departing from the spirit or essential characteristics thereof.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A lighting device comprising:
a diffusion plate including one main surface, the other main surface on an opposite side of the one main surface, and an end surface between the one main surface and the other main surface, the diffusion plate containing a diffuser for scattering light; and
at least one light source disposed on the one main surface side,
wherein the end surface emits light by light from the light source entering the diffusion plate through the one main surface, being scattered by the diffuser, and exiting from the end surface.

2. The lighting device according to claim 1, further comprising
a first reflecting surface disposed on the other main surface side and configured to reflect light from the light source that has transmitted through the diffusion plate, wherein
the end surface emits light by light from the light source entering the diffusion plate through the one main surface and being scattered by the diffuser, and by reflected light from the first reflecting surface entering the diffusion plate through the other main surface and being scattered by the diffuser, and exiting from the end surface.

3. The lighting device according to claim 2, further comprising
a second reflecting surface disposed on the one main surface side and configured to reflect light from the light source, wherein
the end surface emits light by light from the light source entering the diffusion plate through the one main surface and being scattered by the diffuser, by reflected light from the first reflecting surface entering the diffusion plate through the other main surface and being scattered by the diffuser, and by reflected light from the second reflecting surface entering the diffusion plate through the one main surface and being scattered by the diffuser, and exiting from the end surface.

4. The lighting device according to claim 3, wherein
the first reflecting surface and the second reflecting surface are each made of a highly reflective member.

5. The lighting device according to claim 1, further comprising
a light-shielding member that surrounds at least a part of the end surface in a front view.

6. The lighting device according to claim 1, wherein
the light source is disposed at a position where light within a half-value angle with respect to an optical axis of the light source does not directly exit from the end surface.

7. The lighting device according to claim 1, wherein
the light source is a film light source including an elongated film having flexibility and extending in a longitudinal direction, and at least one semiconductor light-emitting element fixed to at least a surface of the film.

8. The lighting device according to claim 7, wherein
the semiconductor light-emitting elements are a plurality of semiconductor light-emitting elements having different emission colors from each other, and
the semiconductor light-emitting elements are arranged in the longitudinal direction.
